(19) United States
(12) Patent Application Publication
(10) Pub. No.: US 2016/0023824 A1
(43) Pub. Date: Jan. 28, 2016

(54) LEAVES AND DEBRIS DOORWAY

(71) Applicant: Clarence Henry Robinson, Coral Springs, FL (US)

(72) Inventor: Clarence Henry Robinson, Coral Springs, FL (US)

(21) Appl. No.: 14/339,779

(22) Filed: Jul. 24, 2014

(51) Int. Cl. B65D 51/24; B65D 33/01; E06B 7/28; E06B 3/70; E06B 5/00

(52) U.S. Cl. CPC B65D 51/249; E06B 3/70; E06B 5/00; E06B 7/28; B65D 33/01

(57) ABSTRACT

A doorway consists of a frame and two doors. The doorway's purpose is to direct leaves and debris into a container. The doorway with the doors open allows leaves and debris to pass through the angled doors that can redirect leaves and debris into an attached receptacle.

A leaves and debris doorway is a frame with two (2) doors attached that provides a pathway for a leaf blower to blow leaves and debris into a netting bag.

A leaves and debris doorway is made of plastic (organic polymers) that has been molded through injection molding.

A leaves and debris doorway is positioned at a desired area for blowing purposes. Each door is opened to approx. 45 degree angle or desired position. Insert a spike into sleeve at the base of each door.

Insert netting bag holder hooks. Fasten netting bag to hooks while placing netting bag inside of doorway. Extend bag behind doorway

### SUMMARY

Leaves and debris doorway is designed to aid the removal of leaves and debris. This is accomplished by blowing leaves and debris into an collection item; as oppose to blowing items in a pile for pickup.

### DESCRIPTION OF DRAWINGS

FIG. 1. Front view with doors closed.

FIG. 2. Front view with doors open.

FIG. 3. Side view of frame.

FIG. 4. Side view of frame with doors open.

FIG. 5. Overhead view of frame with doors open and image of insert holes.

FIG. 6. Overhead view of frame with doors open, and image of netting bag attached.

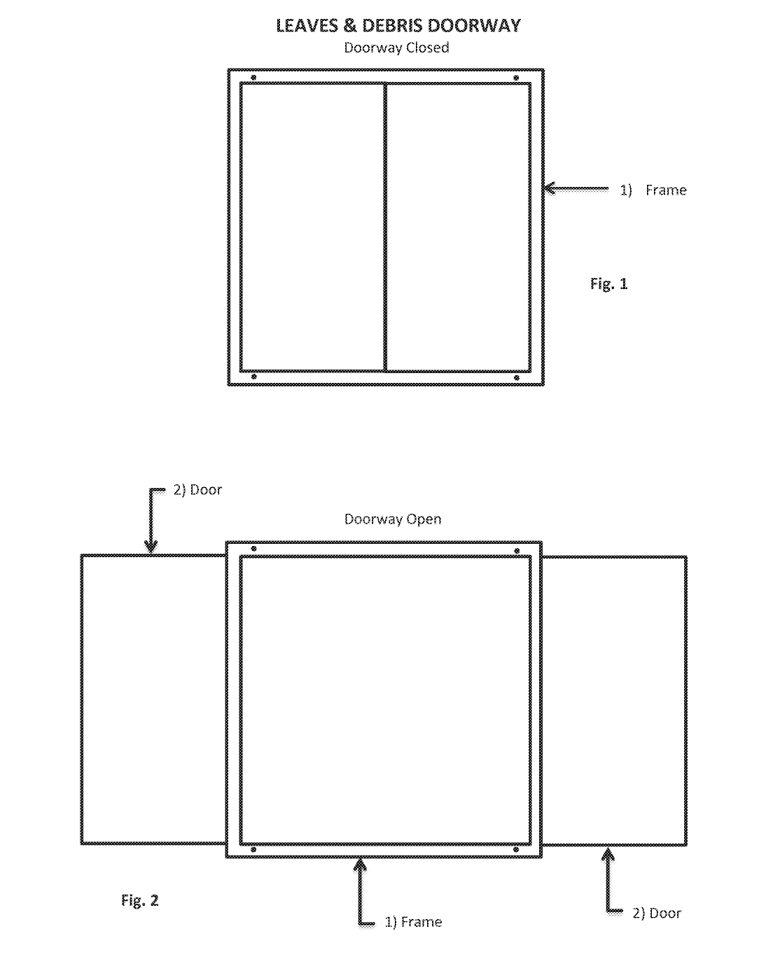

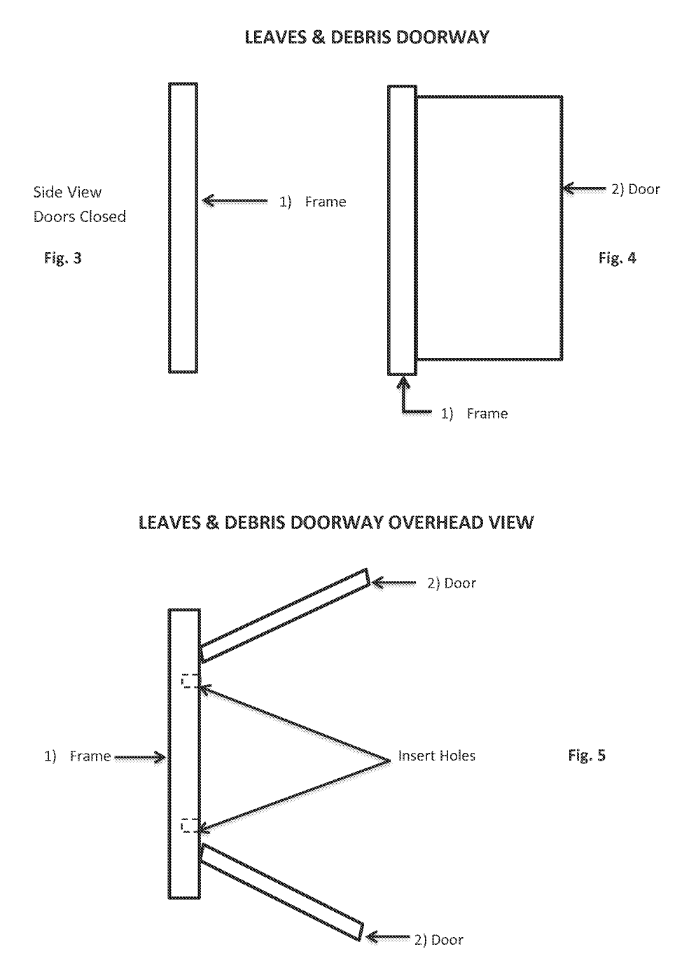

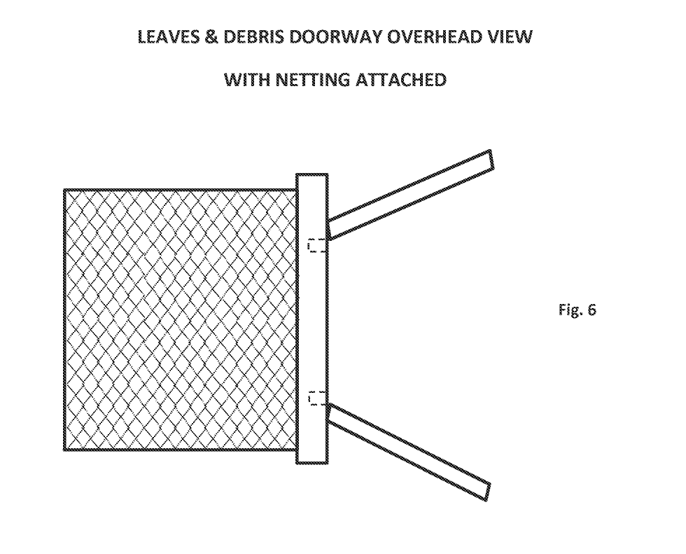

1) A doorway to direct leaves and debris.

2) A frame to attach two doors; and

3) Two doors.
